(19) United States
(12) Patent Application Publication
(10) Pub. No.: US 2021/0151836 A1
(43) Pub. Date: May 20, 2021

(54) BATTERY CELL WITH ANODE LAYER PROTRUSION AND/OR CATHODE LAYER PROTRUSION CONTACTED ON THE SEPARATOR SIDE AND/OR ON THE FRONT SIDE

(71) Applicant: Robert Bosch GmbH, Stuttgart (DE)

(72) Inventors: Harald Bauer, Ehningen (DE); Wolfgang Weydanz, Buckenhof (DE)

(21) Appl. No.: 16/635,988

(22) PCT Filed: Jul. 31, 2018
(86) PCT No.: PCT/EP2018/070688

§ 371 Date: Jan. 31, 2020

(30) Foreign Application Priority Data
Aug. 2, 2017 (DE) 10 2017 213 377.5

(51) Int. Cl. H01M 50/533; H01M 10/04; H01M 10/052; H01M 10/0585; H01M 50/54; H01M 4/36; H01M 4/62

(52) U.S. Cl. CPC H01M 50/533; H01M 10/0413; H01M 10/052; H01M 4/626; H01M 50/54; H01M 4/366; H01M 10/0585

(57) ABSTRACT

The present invention relates to a battery cell (10), in particular a lithium cell, which comprises an anode layer (1), a cathode layer (2) and a separator layer (3) arranged between the anode layer (1) and the cathode layer (2). In order to reduce the thickness of the layer structure of the battery cell (10) and to improve its volumetric and/or gravimetric energy density, in particular in a cost-saving and/or weight-saving manner, the anode layer (1) has at least one anode layer protrusion (1a) projecting beyond the separator layer (3) and/or the cathode layer (2) has at least one cathode layer protrusion (2a) projecting beyond the separator layer (3), wherein the at least one anode layer protrusion (1a) and/or the at least one cathode layer protrusion (2a) serve(s) as a current conductor and is/are electrically contacted on the separator side and/or on the front side. The invention further relates to a battery of this kind and to a method for producing a battery cell (10) and battery of this kind.

### BACKGROUND OF THE INVENTION

The present invention relates to a battery cell, especially a lithium cell, and to a corresponding battery and to a process for production thereof.

Battery electrodes for battery cells such as lithium cells are conventionally produced by a wet, i.e. solvent-based, process, for example by what is called a slurry process. This typically involves coating a metallic conductor foil that serves as output conductor on one or both sides.

Alternatively, battery electrodes for battery cells, such as lithium cells, can be manufactured as free-standing electrode films, for example by extrusion and/or rolling-out. It is optionally also possible here to produce free-standing electrode films by a dry, i.e. solvent-free, process. In the production of self-supporting electrode films, one electrode film each is conventionally applied, for example by laminating, to a metallic conductor foil that serves as output conductor.

Conventionally, battery cells such as lithium cells have an anode layer, a cathode layer, and a separator layer disposed between the anode layer and the cathode layer. Typically, the anode layer here is electrically contacted via a metallic conductor foil that serves as anode output conductor and is disposed on the side of the anode layer remote from the separator layer—and hence remotely from the separator. Analogously, the cathode layer as well is typically electrically contacted via a metallic conductor foil that serves as cathode output conductor and is disposed on the side of the cathode layer remote from the separator layer—and hence remotely from the separator.

Such electrical contacting remote from the separator via the metallic conductor foils that serve as anode output conductor and cathode output conductor conventionally also exists in the case of metallic conductor foils that serve as anode output conductor and cathode output conductor and are provided on each side with an anode layer and cathode layer, for example which are stacked in such a way that this forms an electrical series connection of multiple battery cells.

Publications U.S. Pat. No. 6,589,299 B2, WO 2005/049700 A1, US 2005/0266298 A1, JP 2015-185403 and U.S. Pat. No. 9,553,303 B2 relate to processes for producing electrodes.

### SUMMARY OF THE INVENTION

The present invention provides a battery cell, for example a lithium cell or a sodium cell, for example a lithium metal cell and/or a lithium ion cell and/or a sodium ion cell, especially a lithium cell, for example a lithium metal cell and/or a lithium ion cell, comprising an anode layer, a cathode layer, and a separator layer disposed between the anode layer and the cathode layer.

More particularly, the anode layer here has at least one anode layer excess that projects beyond the separator layer and/or the cathode layer has at least one cathode layer excess that projects beyond the separator layer. The at least one anode layer excess and/or the at least one cathode layer excess serves here especially as output conductor and is electrically contacted on the separator side and/or at the end face.

“On the separator side” may especially be understood to mean on a side of the anode layer excess or of the cathode layer excess facing the separator layer of the cell.

“At the end face” may especially be understood to mean on an end face, for example a narrow end face, of the anode layer excess, especially facing away from a/the electrochemically active section of the anode layer, or on an end face, for example a narrow end face, of the cathode layer excess, especially facing away from a/the electrochemically active section of the cathode layer.

By virtue of the anode layer excess or cathode layer excess projecting beyond the separator layer and especially also beyond the actual electrochemically active area of the anode and the cathode or of the cell, the anode layer excess and hence the anode layer or the cathode layer excess and hence the cathode layer can advantageously and unusually be electrically contacted on the separator side, i.e. via the side facing the separator layer, and/or at the end face, i.e. via an end face of the respective electrode layer excess, especially anode layer excess or cathode layer excess, facing away from the electrochemically active section of the respective electrode layer, especially anode layer or cathode layer.

It is possible here for the anode layer excess or cathode layer excess that projects beyond the separator layer to advantageously create a certain construction space, via which the anode layer excess or cathode layer excess can be electrically contacted on the separator side and/or at the end face.

This is because, according to the material system of the electrode layer, for example anode layer or cathode layer, it may advantageously be the case, especially also with small layer thicknesses of the electrode layer, that the electrical conductivity of the electrode layer, for example in the case of battery cells which have been optimized for high energy density at the cell level, for example, for use in electrical vehicles and/or hybrid vehicles and/or plug-in hybrid vehicles and/or stationary power storage facilities, is already sufficient for conduction of currents within and out of the electrode layer. This may be particularly advantageous when the electrical conductivity of the electrode layer is high, for example in the case of an anode layer of very good conductivity, for example of lithium metal, and/or when the batteries are stacked. This is because, in the case of stacked battery cells, it is possible for the electrical pathways within the electrode layers to be short compared to wound battery cells and hence for adequate electrical contacting to be implemented in an advantageously simpler manner, for example with a lower cross section and/or lower electrical conductivity.

By virtue of the anode layer excess or cathode layer excess itself serving as output conductor, it is advantageously possible—especially on the side remote from the separator side of the cell—in the case of the anode layer to dispense with an additional metallic conductor foil serving as anode output conductor that has been customary to date, typically having a layer thickness within a range from about ≥6 μm to about ≤20 μm, and/or in the case of the cathode to dispense with an additional metallic conductor foil serving as cathode output conductor that has been customary to date, typically having a layer thickness within a range from about ≥10 μm to about ≤25 μm.

The battery cell may therefore, for example, be free of a metallic conductor foil that serves as anode output conductor on the side of the anode layer remote from the separator layer of the cell, and/or free of a metallic conductor foil that serves as cathode output conductor on the side of the cathode layer remote from the separator layer. More particularly, the battery cell here may be free of a metallic conductor foil that serves as anode output conductor on the side of the anode layer remote from the separator layer of the cell.

Moreover, by virtue of the anode layer excess or cathode layer excess being electrically contacted on the separator side, by virtue of the separator layer which may have, for example, a layer thickness within a range from about ≥10 μm to about ≤150 μm and may optionally also have a thicker configuration, and optionally additionally by virtue of the cathode layer which may have, for example, a layer thickness within a range from about ≥50 μm to about ≤200 μm and may optionally also have a thicker configuration, it is advantageously possible to provide construction space, especially construction height, for an electrical contact element via which the electrode layer is electrically connected to the pole of the battery cell and/or battery and/or to electrode layers of further battery cells and which may have, for example, a thickness of about ≥15 μm to about ≤50 μm or possibly even up to ≤200 μm, for example for what is called a conductor tab or what is called a contact tab.

For example, the construction height of an electrical contact element applied to the separator side of the anode layer excess, for example in the form of a customary conductor tab or contact tab, for example having a thickness of about ≥15 μm to about ≤50 μm or more, may project into a space in the region of the layer thickness of the separator layer, for example of ≥10 μm to about ≤150 μm, and optionally additionally into a space in the region of the layer thickness of the cathode layer, for example of about ≥50 μm to about ≤200 Analogously, for example, the construction height of an electrical contact element applied to the separator side of the cathode layer excess, for example in the form of a customary conductor tab or contact tab, for example having a thickness of about ≥15 μm to about ≤50 μm or more, may project into a space in the region of the layer thickness of the separator layer, for example of ≥10 μm to about ≤150 and optionally additionally into a space in the region of the layer thickness of the anode layer.

Firstly, the improved utilization of construction space in the cell stack direction and/or the dispensing with the additional metallic conductor foil remote from the separator that serves as output conductor can advantageously distinctly reduce the layer structure thickness of the battery cell and hence of a battery cell stack formed therefrom. It is especially possible here to reduce the layer structure thickness of the battery cell to a much more significant degree than would be possible in the case of a conventional cell structure via the use of an additional two-dimensional output conductor in the form of a thin metallic coating remote from the separator and/or via a thin electrode layer. This is because, in both cases, in a conventional cell construction, the comparatively thick electrical contact element, for example a conductor tab or a contact tab, typically having a thickness of about ≥15 μm to about ≤50 μm or possibly even up to ≤200 in a conventional cell construction generally cannot be sunk in a thin metallic coating that serves as output conductor and/or in a thin electrode layer, for example of lithium metal, for example having a layer thickness of below 50 μm, and hence structure layer thickness is lost.

Secondly, the dispensing with the additional two-dimensional output conductor can advantageously improve the volumetric and/or gravimetric energy density of the battery cell through avoidance of components, especially electrochemically inactive components, that do not contribute to the actual energy storage. Furthermore, it is possible in this way to reduce costs and weight and/or volume, for example through avoidance of use of copper foils as anode output conductor. It may be the case here, especially on the anode side, that the cost of material saved through avoidance of a metal foil as output conductor, for example a copper foil as anode output conductor, is considerable and can compensate for additional active material required to form the anode layer excess or cathode layer excess. Such a material cost saving may be particularly high especially in the case of inexpensive electrode materials, such as graphite and/or carbon electrodes.

In addition, by dispensing with the additional two-dimensional output conductor remote from the separator and hence losing the sealing effect thereof, it is advantageously possible to simplify introduction of electrochemical solutions into the battery cell and conduct processes for electrolyte filling or wetting with a distinctly shorter process time.

Overall, it is advantageously possible in this way to provide a battery cell in a cost- and/or weight-saving manner with a reduced layer structure thickness—and especially with an improved volumetric and/or gravimetric energy density.

The at least one anode layer excess and/or the at least one cathode layer excess may be electrically contacted, for example, (at least) on the separator side. For example, the at least one anode layer excess and/or the at least one cathode layer excess may be electrically contacted on the separator side and at the end face.

The at least one anode layer excess may especially project beyond one side of the separator layer. The at least one cathode layer excess may especially project beyond one side, especially another side, of the separator layer.

The anode layer—especially in addition to the at least one anode layer excess—may have an electrochemically active section, especially in an overlapping arrangement with an electrochemically active section of the cathode layer, separated by the separator layer. The at least one anode layer excess of the anode layer may especially project beyond the electrochemically active section of the anode layer and of the cathode layer and beyond the separator layer and hence be considered to be electrochemically inactive.

The cathode layer—especially in addition to the at least one cathode layer excess—may have an electrochemically active section, especially in an overlapping arrangement with a/the electrochemically active section of the anode layer, separated by the separator layer. The at least one cathode layer excess of the cathode layer may especially project beyond the electrochemically active section of the cathode layer and of the anode layer and beyond the separator layer and hence be considered to be electrochemically inactive.

In the context of one embodiment, the at least one anode layer excess projects beyond the separator layer, especially beyond one side of the separator layer, and beyond the cathode layer, especially beyond one side of the cathode layer.

In the context of an alternative or additional further embodiment, the at least one cathode layer excess projects beyond the separator layer, especially beyond one side, especially another side, of the separator layer, and beyond the anode layer, especially beyond one side, especially another side, of the anode layer.

In this way, it is advantageously possible to increase the construction space, especially the construction height, available for an electrical contact element for electrical contacting of the anode layer excess or cathode layer excess with a pole of the battery cell and/or battery and/or with anode layers or contact layers of further battery cells. An anode layer excess that projects beyond the separator layer and the cathode layer can advantageously achieve a particularly large amount of free construction space, especially free construction height, since the cathode layer is generally particularly thick compared to the separator layer and to the anode layer.

The anode layer and/or the cathode layer may optionally be supported by the separator layer. It is possible here, for example, for solely the at least one anode layer excess and/or the at least one cathode layer excess in particular to have a self-supporting configuration.

In the context of a further embodiment, however, the anode layer, especially the complete anode layer, for example including the at least one anode layer excess, and/or the cathode layer, especially the complete cathode layer, for example including the at least one cathode layer excess, is a self-supporting layer. For example, the anode layer and/or the cathode layer may be a self-supporting electrode film, a self-supporting electrode composite and/or a self-supporting sintered electrode, optionally in any desired form. In this way, it is possible to dispense with a metallic conductor foil, especially a supporting metallic conductor foil, that serves as anode output conductor or cathode output conductor, especially on the side of the anode layer or cathode layer remote from the separator layer and/or else with a supporting function of the separator layer, and in this way to reduce production complexity, save costs and/or weight, and/or to improve the volumetric and/or gravimetric energy density of the battery cell.

The cell construction of the invention can additionally advantageously simplify or facilitate the production of self-supporting electrode layers since the anode layer or cathode layer—compared to anode layers or cathode layers applied to both sides of a metallic conductor foil—can be formed with twice the thickness. For example, it is possible in this way to increase an extrusion gap for production of the self-supporting electrode layer by means of extrusion and, for example, sintering to a dimension which is more readily amenable to manufacturing. In this way, it is advantageously possible to simplify the production of the anode layer or cathode layer and/or increase the accuracy thereof and/or mechanically simplify handling. The volumetric or gravimetric energy density—as compared with the use of a metallic conductor foil that serves as an output conductor—may be essentially unaffected here by an elevated layer thickness of the anode layer or cathode layer since the material here is electrochemically active—and not electrochemically inactive—material.

In the context of a further embodiment, the anode layer has a layer thickness within a range from ≥20 μm to ≤400 μm and/or the cathode layer has a layer thickness within a range from ≥20 μm to ≤600 μm.

In the context of a further embodiment, the at least one anode layer excess extends along an edge of the anode layer and/or the at least one cathode layer excess extends along an edge of the cathode layer. For example, the at least one anode layer excess may extend beyond a portion, especially a majority, of the full length of an edge of the anode layer, optionally over the full length of an edge of the anode layer. Correspondingly, for example, the at least one cathode layer excess may extend beyond a portion, especially a majority, of the full length of an edge of the cathode layer, optionally over the full length of an edge of the cathode layer.

Extension of the at least one anode layer excess and/or cathode layer excess over part of the length of an edge of the anode layer or cathode layer, given suitable cell mechanics, may especially be advantageous with regard to improved exploitation of construction space in the battery cell. Extension of the at least one anode layer excess and/or cathode layer excess over the full length of an edge of the anode layer or cathode layer may especially be advantageous with regard to a low electrical resistance.

For example, the at least one anode layer excess and/or the at least one cathode layer excess may project beyond the separator layer by ≥1 mm, for example by ≥2 mm, optionally by ≥5 mm, for example by ≥1 mm or ≥2 mm to ≤10 mm.

In the context of a further embodiment, an anode layer contact element for electrical contacting of the anode layer has been applied on the separator side and/or at the end face on the at least one anode layer excess and/or a cathode layer contact element for electrical contacting of the cathode layer has been applied on the separator side and/or at the end face on the at least one cathode layer excess. More particularly, an anode layer contact element for electrical contacting of the anode layer may have been applied on the separator side on the at least one anode layer excess and/or a cathode layer contact element for electrical contacting of the cathode layer may have been applied on the separator side on the at least one cathode layer excess. For example, an anode layer contact element for electrical contacting of the anode layer may have been applied on the separator side and at the end face on the at least one anode layer excess and/or a cathode layer contact element for electrical contacting of the cathode layer may have been applied on the separator side and at the end face on the at least one cathode layer excess.

The anode layer contact element may especially be designed for electrical contacting of the anode layer with a pole of the battery cell and/or battery and/or with an electrode layer, for example an anode layer, of another battery cell. The cathode layer contact element may especially be designed for electrical contacting of the cathode layer with a pole, especially another pole, of the battery cell and/or battery and/or with an electrode layer, for example a cathode layer, of another battery cell.

The anode layer contact element may especially be an anode output conductor strip, for example in the form of a metal strip, and/or the cathode layer contact element for electrical contacting of the cathode layer may be a cathode output conductor strip, for example in the form of a metal strip. More particularly, the anode output conductor strip and/or the cathode output conductor strip may be configured in the form of a flat strip, for example a simple flat strip, especially in nonangulate form, for example a metal strip. However, it is also possible to configure the anode output conductor strip and/or the cathode output conductor strip in the form of an angulate strip, for example metal strip, for example with an L-shaped cross section. It is possible here to apply an anode output conductor strip and/or cathode output conductor strip to the at least one anode layer excess or to the at least one cathode layer excess in the form of an angulate strip, for example both on the separator side and at the end face.

In the context of a further embodiment, the anode layer contact element, especially the anode output conductor strip, projects at least beyond one edge of the anode layer and/or the cathode layer contact element, especially the cathode output conductor strip, projects at least beyond one edge of the cathode layer. For example, the anode layer contact element, especially the anode output conductor strip, may project at least beyond a lateral and/or terminal edge, especially lateral edge, of the anode layer and/or the cathode layer contact element, especially the cathode output conductor strip, may project at least beyond a lateral and/or terminal edge, especially lateral edge, of the cathode layer.

In the context of a further embodiment, the at least one anode layer excess and/or the at least one cathode layer excess is especially provided with an electrically conductive coating on the separator side, especially on a surface facing the separator layer of the cell. In this way, it is advantageously possible to improve the electrical binding of the anode layer contact element or of the cathode layer contact element. This may especially be advantageous if the at least one anode layer excess and/or the anode layer or the at least one cathode layer excess and/or the cathode layer is formed from a particulate and/or porous material. If the at least one anode layer excess and/or the anode layer or the at least one cathode layer excess and/or the cathode layer is formed from a metallic and/or nonporous or permeable material, for example if the at least one anode layer excess and/or the anode layer is formed from lithium metal, it is optionally possible to dispense with the electrically conductive coating on the separator side and/or with the electrically conductive coatings elucidated hereinafter.

If the at least one anode layer excess and/or the at least one cathode layer excess has been provided with an electrically conductive coating on the separator side, the anode layer contact element or the cathode layer contact element may especially have be applied or be applied to the separator side of the electrically conductive coating on the separator side of the at least one anode layer excess or of the at least one cathode layer excess.

More particularly, the electrically conductive coating on the separator side of the at least one anode layer excess and/or of the at least one cathode layer excess may be a metallic coating, especially in the form of a metallization.

For example, the electrically conductive coating on the separator side of the at least one anode layer excess and/or of the at least one cathode layer excess may have a layer thickness of ≤5 μm, for example of ≤4 μm or ≤3 μm or ≤2 μm or ≤1.5 μm, for example of ≤1.2 μm. Suitable electrical conductivities may advantageously already be achieved by electrically conductive, especially metallic and/or carbonaceous, coatings having a layer thickness of less than 1.2 μm.

In the context of a further, additional or alternative embodiment, the at least one anode layer excess and/or the at least one cathode layer excess has been provided with an electrically conductive coating at an end face. In this way, it is possible to increase the electrical conductivity of the at least one anode layer excess and/or of the at least one cathode layer excess.

If the at least one anode layer excess and/or the at least one cathode layer excess has been provided with an electrically conductive coating on an end face, the anode layer contact element or cathode layer contact element may optionally have been applied or be applied to the electrically conductive coating on the end face of the at least one anode layer excess or of the at least one cathode layer excess.

More particularly, the electrically conductive coating on the end face of the at least one anode layer excess and/or of the at least one cathode layer excess may be a metallic coating, especially in the form of a metallization.

For example, the electrically conductive coating on the end face of the at least one anode layer excess and/or of the at least one cathode layer excess may have a layer thickness of ≤5 for example of ≤4 μm or ≤3 μm or ≤2 μm or ≤1.5 for example of ≤1.2 Suitable electrical conductivities may advantageously already be achieved by electrically conductive, especially metallic and/or carbonaceous, coatings having a layer thickness of less than 1.2 μm.

In the context of a further, additional or alternative embodiment, the at least one anode layer excess and/or the at least one cathode layer excess, especially on a surface remote from the separator layer of the cell, has additionally been provided with an electrically conductive coating remote from the separator. In this way, it is likewise possible to increase the electrical conductivity of the at least one anode layer excess and/or of the at least one cathode layer excess. More particularly, it is additionally possible to provide the at least one anode layer excess and/or the at least one cathode layer excess of the outermost electrode(s) of the outermost battery cell(s) of a battery cell stack with an electrically conductive coating remote from the separator.

More particularly, the electrically conductive coating remote from the separator on the at least one anode layer excess and/or on the at least one cathode layer excess may be a metallic coating, especially in the form of a metallization.

For example, the electrically conductive coating remote from the separator on the at least one anode layer excess and/or on the at least one cathode layer excess may have a layer thickness of ≤5 for example of ≤4 μm or ≤3 μm or ≤2 μm or ≤1.5 for example of ≤1.2 μm. Suitable electrical conductivities may advantageously already be achieved by electrically conductive, especially metallic and/or carbonaceous, coatings having a layer thickness of less than 1.2 μm.

In the context of a further, additional or alternative embodiment, a or the electrochemically active section of the anode layer and/or a or the electrochemically active section of the cathode layer has additionally been provided with an electrically conductive coating remote from the separator, especially on a surface remote from the separator layer of the cell. In this way, it is possible to increase the electrical conductivity further. More particularly, it is additionally possible to provide the electrochemically active section of the anode layer and/or the electrochemically active section of the cathode layer of the outermost electrode(s) of the outermost battery cell(s) of a battery cell stack with an electrically conductive coating remote from the separator.

More particularly, the electrically conductive coating remote from the separator on the electrochemically active section of the anode layer and/or on the electrochemically active section of the cathode layer may be a metallic coating, especially in the form of a metallization.

For example, the electrically conductive coating remote from the separator on the electrochemically active section of the anode layer and/or on the electrochemically active section of the cathode layer may have a layer thickness of ≤5 μm, for example of ≤4 μm or ≤3 μm or ≤2 μm or ≤1.5 μm, for example of ≤1.2 μm. Suitable electrical conductivities may advantageously already be achieved by electrically conductive, especially metallic and/or carbonaceous, coatings having a layer thickness of less than 1.2 μm.

In the context of one configuration, the electrically conductive coating on the separator side and/or the electrically conductive coating at the end face and/or the electrically conductive coating remote from the separator on the at least one anode layer excess and/or on the at least one cathode layer excess and/or on the electrically conductive coating remote from the separator on the electrochemically active section of the anode layer and/or of the cathode layer have been coated in such a way that the electrically conductive coating penetrates into a porosity of the anode layer or cathode layer. In this way, it is advantageously possible to increase the contact area and/or improve the transfer resistance, which can have an advantageous effect on the performance of the cell.

In the context of a further, additional or alternative embodiment, the at least one anode layer excess has been formed from a material having a higher electrical conductivity than a or the material from which a or the electrochemically active section of the anode layer has been formed and/or the at least one cathode layer excess has been formed from a material having a higher electrical conductivity than a or the material from which the electrochemically active layer of the cathode layer has been formed. In this way, it is likewise possible to increase the electrical conductivity of the at least one anode layer excess and/or the at least one cathode layer excess.

In principle, the anode layer may have such an anode layer excess on one or more sides and/or the cathode layer may have a cathode excess on one or more sides.

If the battery cell has both at least one anode layer excess and at least one cathode layer excess, the at least one anode layer excess and the at least one cathode layer excess preferably project beyond different sides, for example opposite sides, of the separator layer.

The separator layer may especially have a larger area than the anode layer and/or the cathode layer. In this way, it is advantageously possible to compensate for manufacturing and assembly tolerances and increase the safety and lifetime of the cell.

In one configuration, the anode layer has a greater area than the cathode layer. In this case, the separator layer may at least have a greater area than the cathode layer. It is optionally possible here for the separator layer to have a greater area than the anode layer and the cathode layer.

In another configuration, the cathode layer has a greater area than the anode layer. The separator layer here has at least a greater area than the anode layer. It may be the case here that the separator layer has a greater area than the anode layer and the cathode layer.

In the context of a further embodiment, the separator layer has, on at least one side free of anode layer excess, at least one separator layer excess that projects beyond the anode layer and/or, on at least one side free of cathode layer excess, at least one separator layer excess that projects beyond the cathode layer. For example, the separator layer may have separator layer excesses that project beyond the anode layer on the/all sides free of anode layer excess and/or separator layer excesses that project beyond the anode layer on the/all sides free of cathode layer excess. In this way, it is advantageously possible to compensate for manufacturing and assembly tolerances and increase the safety and lifetime of the cell.

The anode layer here may have—especially between the at least one anode layer excess and the electrochemically active section of the anode layer—at least one anode layer transition section, especially in an overlapping arrangement with at least one separator layer excess that projects beyond the cathode layer. Especially if the anode layer has a greater area than the cathode layer, the anode layer may optionally additionally have—especially in addition to the at least one anode layer excess, the electrochemically active section and the anode layer transition section—at least one anode layer edge section, especially in an overlapping arrangement with at least one separator layer excess projecting beyond the cathode layer.

The cathode layer here may have—especially between the at least one cathode layer excess and the electrochemically active section of the cathode layer—at least one cathode layer transition section, especially in an overlapping arrangement with at least one separator layer excess that projects beyond the anode layer. Especially if the cathode layer has a greater area than the anode layer, the cathode layer may optionally additionally have—especially in addition to the at least one cathode layer excess, the electrochemically active section and the cathode layer transition section—at least one cathode layer edge section, especially in an overlapping arrangement with at least one separator layer excess projecting beyond the anode layer.

The anode layer and/or the at least one anode layer excess and/or the electrochemically active section of the anode layer and/or the at least one anode layer transition section and/or the at least one anode layer edge section may be formed, for example, either from a metallic and/or nonporous or permeable material or from a particulate and/or porous material.

For example, the anode layer and/or the at least one anode layer excess and/or the electrochemically active section of the anode layer and/or the at least one anode layer transition section and/or the at least one anode layer edge section may have been formed from a material comprising or formed from lithium metal and/or an alloy metal, for example silicon and/or tin, and/or an alloy metal-carbon composite, for example a silicon-carbon composite, and/or silicon carbide and/or a mixed silicon carbide phase. Such materials can advantageously form self-supporting or free-standing electrode layers, for example electrode films.

In the context of a specific configuration, the anode layer and/or the at least one anode layer excess and/or the electrochemically active section of the anode layer and/or of the at least one anode layer transition section and/or of the at least one anode layer edge section is formed from lithium metal. In this way, it is possible to achieve a particularly high volumetric and/or gravimetric energy density of the battery cell and additionally to achieve very good electrical contacting via the at least one anode layer excess.

In the context of another specific configuration, the anode layer and/or the at least one anode layer excess and/or the electrochemically active section of the anode layer and/or the at least one anode layer transition section and/or the at least one anode layer edge section comprises or is formed from an alloy metal-carbon composite, for example based on silicon and/or tin, for example a silicon-carbon composite. Alloy metal-carbon composites, especially silicon-carbon composites, can form the at least one anode layer excess and/or the anode layer in a particularly inexpensive manner. The cell construction of the invention advantageously also enables electrical contacting, in a simple manner, of self-supporting anode layers based on alloy metal-carbon composites, especially silicon-carbon composites, that it has not yet been possible to laminate onto metallic conductive films in an advantageous manner, especially on both sides.

The cathode layer and/or the at least one cathode layer excess and/or the electrochemically active section of the cathode layer and/or the at least one cathode layer transition section and/or the at least one cathode layer edge section may have been formed, for example, either from a nonporous or permeable material or from a particulate and/or porous material.

In the context of one configuration, the anode layer is formed by only one anode layer sheet, for example a thick anode layer sheet, for example having a layer thickness of ≥100 for example within a range from ≥20 μm to ≤400 and/or the cathode layer is formed by only one cathode layer sheet, for example a thick cathode layer sheet, for example having a layer thickness of ≥100 for example within a range from ≥20 μm to ≤600 More particularly, the anode layer may be formed by only one anode layer sheet, for example a thick anode layer sheet, for example having a layer thickness of ≥100 for example within a range from ≥20 μm to ≤400 In this way, it is advantageously possible to reduce the processing distance and/or the deployment in m²/min in the production and hence to make the production simpler and less expensive.

In the context of another configuration, the anode layer has an anode layer sheet equipped with the at least one anode layer excess and at least one or more than one additional, especially self-supporting, anode layer sheets, and/or the cathode layer has a cathode layer sheet equipped with the at least one cathode layer excess and at least one or more than one additional, especially self-supporting, cathode layer sheets. The at least one additional anode layer sheet or cathode layer sheet here may especially have just one electrochemically active section and/or, for example, no excess that projects beyond the separator layer and/or may have be applied on the side remote from the separator, for example on the electrically conductive coating remote from the separator on the anode layer sheet equipped with the at least one anode layer excess or on the cathode layer sheet equipped with the at least one cathode layer excess.

More particularly, the battery cell may have at least one anode layer having at least one anode layer excess. Currently available anode layer materials may have a higher electrical conductivity than currently available cathode layer materials, and for that reason electrical contacting of anode layer excesses is currently more advantageous.

In the context of a further configuration, the cathode layer may have a metallic conductive film that serves as cathode output conductor, for example of aluminum. For example, the cathode layer may comprise a metallic conductor film that has been provided, for example coated, with a cathode layer sheet on each side and serves as cathode output conductor. It is possible here for the cathode layer sheets each to have, for example, a layer thickness within a range from about ≥10 μm or about ≥50 μm to about ≤200 μm or optionally to about ≤300 The metallic conductor film that serves as cathode output conductor may have been equipped here with a cathode layer contact element, for example with a cathode output conductor tab that has optionally been welded on. Since a distinctly greater material layer thickness than for the formation of the anode layer, for which—particularly owing to the high capacity of lithium metal and also of silicon and/or tin and/or other alloy metals—only low layer thicknesses of less than 50 μm are needed, is typically required for the formation of the cathode layer or of the cathode layer sheets thereof, the thickness of the cathode layer contact element, for example of the cathode output conductor tab, may be lower than the layer thickness of the cathode layer. The geometric construction of the battery cell may therefore advantageously barely be disrupted by a cathode layer contact element, especially by a cathode output conductor tab—or more particularly to a lesser degree than by an anode output conductor tab.

In the context of a further embodiment, the separator layer takes the form of a packing of separator material, for example in the form of a pouch packed with the cathode layer, for example inserted and packed. The cathode layer here may especially be packed circumferentially in the packing of separator material. The packings of separator material here may advantageously, in addition to the function as a separator, also implement electrical insulation of the battery cell from adjacent battery cells in a battery.

In the context of another embodiment, the separator layer is a layer, especially a simple layer, of separator material.

The battery cell of the invention may especially be used in a battery of the invention elucidated hereinafter and/or produced by a process of the invention elucidated later.

For further technical features and advantages of the battery cell of the invention, reference is hereby made explicitly to the elucidations in association with the battery of the invention and the production process of the invention, and to the figures and the description of figures.

The invention further provides a battery, especially a lithium battery or sodium battery, for example a lithium metal battery and/or a lithium ion battery or a sodium ion battery, for example for a vehicle, such as an electrical vehicle and/or a hybrid material and/or a plug-in hybrid vehicle and/or a stationary power storage facility, comprising at least one battery cell of the invention. More particularly, the battery cell may comprise two or more battery cells of the invention.

In the context of one embodiment, the battery comprises a cell stack composed of two or more battery cells of the invention. More particularly, the battery cells may be stacked here such that the anode layer contact elements, especially the anode output conductor strips, and/or the cathode layer contact elements, especially the cathode output conductor strips, are each aligned in a common plane, and are optionally arranged in a straight line.

In the context of a further embodiment, an anode current collector element, for example in the form of a further metal strip, has been secured on the anode layer contact elements, especially on the anode output conductor strips, for example on the end faces and/or side faces of the anode output conductor strips, and/or a cathode current collector element, for example in the form of a further metal strip, has been secured on the cathode layer contact elements, especially on the cathode output conductor strips, for example on the end faces and/or side faces of the cathode output conductor strips, for example by welding, for example by what is called tab welding, and especially electrically connected and mechanically bonded or contacted therewith.

For example, the battery cells may also be stacked in such a way that a cathode layer of each of the battery cells is arranged adjacent to an anode layer of another of the battery cells, or that an anode layer of each of the battery cells is arranged adjacent to a cathode layer of another of the battery cells.

The battery of the invention may especially be produced by a process of the invention elucidated hereinafter.

For further technical features and advantages of the battery of the invention, reference is hereby made explicitly to the elucidations in association with the battery cell of the invention and the production process of the invention, and to the figures and the description of figures.

The invention further relates to a process for producing a battery cell, especially a battery cell of the invention, and/or for producing a battery, especially a battery of the invention.

In the process—for example in a process step a)—it is possible to apply an anode layer contact element for electrical contacting of the anode layer, especially an anode output conductor strip, for example in the form of a metal strip, to at least one edge section and/or to at least one end face of an anode layer, especially a self-supporting anode layer, and electrically connect it and mechanically bond or contact it with the at least one edge section and/or with the at least one end face, and/or to apply a cathode layer contact element for electrical contacting of the cathode layer, especially a cathode output conductor strip, for example in the form of a metal strip, to at least one edge section and/or to at least one end face of a cathode layer, especially a self-supporting cathode layer, and electrically connect it and mechanically bond or contact it with the at least one edge section and/or with the at least one end face.

The anode layer contact element, especially the anode output conductor strip, and/or the cathode layer contact element, especially the cathode output conductor strip, may be electrically connected and mechanically bonded or contacted with the at least one edge section, for example by clamping and/or by (contact) welding, for example, by ultrasound welding and/or point welding, and/or by soldering, for example by spot welding, and/or by attachment by injection molding and/or casting, for example by metal spraying, and/or by dipping and/or by extrusion and/or by pressing and/or by laminating.

For example, in a process step b), a separator layer is applied to the anode layer alongside the anode layer contact element, especially alongside the anode output conductor strip, and a cathode layer is applied thereto, and/or a separator layer is applied alongside the cathode layer contact element, especially alongside the cathode output conductor strip, and an anode layer is applied thereto. The separator layer and cathode layer may be applied here to the anode layer, or the separator layer and anode layer successively or together to the cathode layer, for example in the form of a component group comprising the separator layer and cathode layer or the separator layer and anode layer.

The production process of the invention can advantageously be configured in a simple manner from a processing point of view since it is possible to dispense, for example, with a process step of applying a metallic conductor film to the anode layer and/or optionally to the cathode layer.

In one embodiment, for example in process step a), the anode layer contact element, especially the anode output conductor strip, and/or the cathode layer contact element, especially the cathode output conductor strip, is applied to the edge section, especially of the anode layer or of the cathode layer, in such a way that the anode layer contact element, especially the anode output conductor strip, or the cathode layer contact element, especially the cathode output conductor strip, projects beyond an edge, for example a lateral and/or terminal edge, especially lateral edge, of the anode layer or beyond an edge, for example a lateral and/or terminal edge, especially a lateral edge, of the cathode layer. For instance, in the case of stacking of multiple battery cells of this kind, the anode layer contact elements, especially anode output conductor strips, or the cathode layer contact elements, especially cathode output conductor strips, may (each) be guided out on one side of the battery cell stack.

In the context of one configuration, for example in process step b), a cathode layer packed in, for example inserted into, a packing of separator material, for example in the form of a pouch, is applied to the anode layer alongside the anode layer contact element, especially alongside the anode output conductor strip, and/or an anode layer packed in, for example inserted into and packed in, a packing of separator material, for example in the form of a pouch, is applied to the cathode layer alongside the cathode layer contact element, especially alongside the cathode output conductor strip. It is especially possible here for the separator layer to be formed by the packing of separator material.

In another configuration, a separator layer in the form of a layer, especially a simple layer, of separator material is applied to the anode layer alongside the anode layer contact element, especially alongside the anode output conductor strip, and a cathode layer is applied in turn to the separator layer, and/or a separator layer in the form of a layer, especially a simple layer, of separator material is applied to the cathode layer alongside the cathode layer contact element, especially alongside the cathode output conductor strip, and an anode layer is applied in turn to the separator layer.

In a further configuration, for example in a process step a0) that precedes process step a), the at least one edge section is coated, especially partly or completely or over the full area, with at least one electrically conductive coating on the separator side, especially in the battery cell produced.

In a further configuration, for example in a process step a0) that precedes process step a), the at least one edge section is coated, especially partly or completely or over the full area, with an electrically conductive coating, including on an end face.

In a further additional or alternative configuration, for example in a process step a0) that precedes process step a), the at least one edge section is coated, especially partly or completely or over the full area, for example on a surface remote from the separator layer of the cell in a battery cell produced, additionally with an electrically conductive coating remote from the separator.

In a further additional or alternative configuration, for example in a process step a0) that precedes process step a), a or the electrochemically active section of the anode layer and/or of the cathode layer is coated, especially partly or completely or over the full area, for example on a surface remote from the separator layer of the cell in the battery cell produced, with an electrically conductive coating remote from the separator.

The coating with the electrically conductive coating or with the electrically conductive coatings can especially be effected by metallizing. The metallizing can be effected here, for example, by a vacuum technique, for example sputtering and/or chemical vapor phase deposition (CVD) and/or physical vapor phase deposition (PVD), and/or by (electro)chemical means, for example by dipping the electrode into a suitable metallization bath, for example with or without application of an electroplating voltage, and/or by vapor deposition and/or by spray application and/or by an injection molding and/or casting technique, for example by thermal spraying, and/or by coating, for example by printing and/or brush application of an electrically conductive lacquer. More particularly, the metallizing can be effected by sputtering.

In a further additional or alternative configuration, the at least one edge section of the anode layer and/or of the cathode layer is formed from a material having a higher electrical conductivity than the material from which a or the electrochemically active section of the anode layer or cathode layer is formed. It is possible here for the at least one edge section of the anode layer or cathode layer, especially the at least one anode layer excess or cathode layer excess, to be formed, for example, by a spraying and/or casting technique, for example by thermal spraying, and/or by extrusion on the electrochemically active section of the anode layer or cathode layer and/or to be endowed with elevated electrical conductivity, for example by dipping.

More particularly, in the process, it is possible to equip at least one edge section of the anode layer with an anode layer contact element, for example anode output conductor strip, and/or to configure at least the anode layer to be free of a metallic conductor foil, for example remote from the separator, that especially serves as output conductor.

The cathode layer here may, for example, have a metallic conductor foil, for example of aluminum, that serves as cathode output conductor. For example, the cathode layer may comprise a metallic conductor foil that has been provided, for example coated, with a cathode layer sheet on either side and serves as cathode output conductor. It is possible here for the cathode layer sheets each to have, for example, a layer thickness within a range from about ≥10 μm or about ≥50 μm to about ≤200 μm or to about ≤300 μm.

The metallic conductor foil that serves as cathode output conductor may be equipped here with a cathode layer contact element, for example a cathode output conductor tab that has been welded on, for example.

In the context of a further embodiment, for example in a process step c), two or more battery cells each having an anode layer, a cathode layer, and a separator layer disposed in between, and at least one anode layer contact element, especially anode output conductor strip, and/or at least one cathode layer contact element, especially cathode output conductor strip, are stacked in such a way that the anode layer contact elements, especially the anode output conductor strips, and/or the cathode layer contact elements, especially the cathode output conductor strips, are each aligned in a common plane, and optionally arranged in a straight line.

For example, in a process step d), it is then possible, for example, to secure an anode current collector element, for example in the form of a further metal strip, on the anode layer contact elements, especially on the anode output conductor strip, for example on the end faces and/or lateral faces of the anode output conductor strips, and/or a cathode current collector element, for example in the form of a further metal strip, on the cathode layer contact elements, especially on the cathode output conductor strip, especially to electrically connect and mechanically bond it or contact it therewith.

By means of the anode current collector element or the cathode current collector element, it is possible to electrically contact the anode layer contact elements or the cathode layer contact elements with one another and/or with a pole of the battery.

The securing of the anode current collector element on the anode layer contact elements, especially on the anode output conductor strips, or the securing of the cathode current collector element on the cathode contact elements, especially on the cathode output conductor strips, and/or the securing of the anode current collector element or cathode current collector element on a pole of the battery can be effected, for example, by an injection molding and/or casting technique, for example by metal casting, and/or by welding and/or by soldering and/or by adhesive bonding, for example with an electrically conductive adhesive.

For example, the securing of the anode current collector element on the anode layer contact elements, especially on the anode output conductor strips, or the securing of the cathode current collector element on the cathode contact elements, especially on the cathode output conductor strips, can be effected by (contact) welding, for example what is called tab welding.

For further technical features and advantages of the production process of the invention, reference is hereby made explicitly to the elucidations in association with the battery cell of the invention and the battery of the invention, and to the figures and the description of figures.

### BRIEF DESCRIPTION OF THE DRAWINGS

Further advantages and advantageous configurations of the subject matter of the invention are illustrated by the drawings and elucidated in the description that follows. It should be noted here that the drawings have merely descriptive character and are not intended to restrict the invention in any way. The figures show:

FIGS. 1, 2, 3a, 3b, 4 and 5 schematic views for illustration of one configuration of one embodiment of the process of the invention for producing a configuration of one embodiment of the battery cell and battery of the invention;

FIGS. 6a,b schematic views for illustration of another configuration of the embodiment of the process of the invention shown in FIGS. 1 to 5 for producing another configuration of an embodiment of the battery cell and battery of the invention;

FIGS. 7a,b schematic views for illustration of a further embodiment of the battery cell of the invention;

FIGS. 8a through 8d schematic cross sections for illustration of further configurations of the embodiments shown in FIGS. 1 to 7b of the process of the invention and of the battery cell and battery of the invention; and

FIG. 9 a schematic perspective view for illustration of a further embodiments of the process of the invention and of the battery cell and battery of the invention.

### DETAILED DESCRIPTION

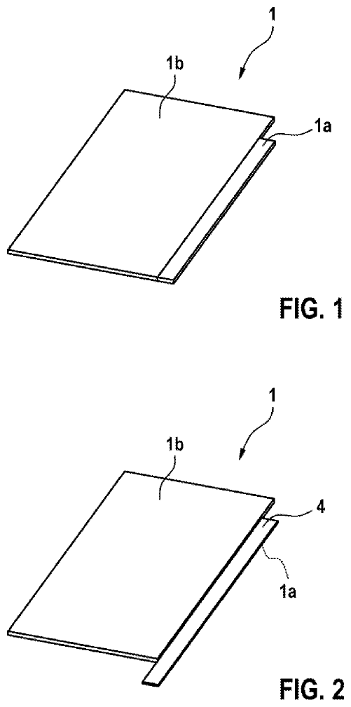

FIGS. 1 to 5 illustrate a configuration of an embodiment of a process of the invention for producing a configuration of an embodiment of a battery cell and battery of the invention, for example a lithium or sodium cell or lithium or sodium battery.

FIG. 1 shows that an anode layer 1, especially a self-supporting anode layer 1, is provided with an edge section 1a that serves later as anode layer excess and with an electrochemically active section 1b. FIG. 1 also shows that the edge section or anode layer excess 1a extends here over a majority of the full length of an edge of the anode layer 1. The edge section or anode layer excess 1a may have, for example, elevated electrical conductivity.

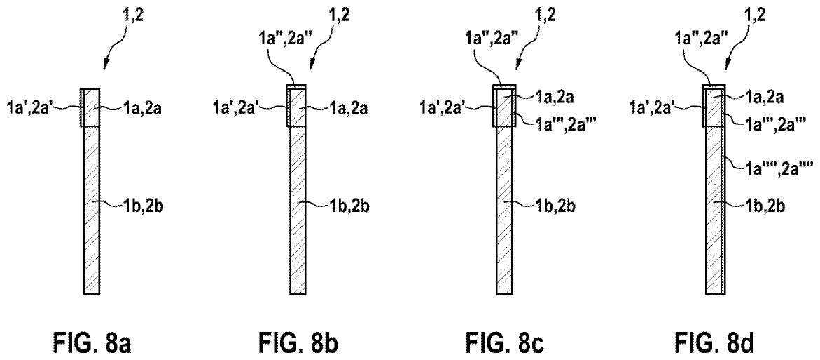

For example, the edge section or anode layer excess 1a may have been coated with at least one electrically conductive coating (not shown in FIGS. 1 to 7b and 9). Possible configurations of this at least one electrically conductive coating are shown in FIGS. 8a to 8d. Alternatively or additionally, the edge section or anode layer excess 1a may have been formed from a material having a higher electrical conductivity than the material from which the electrochemically active section 1b of the anode layer 1 has been formed.

FIG. 2 shows that—for example in a process step a)—an anode output conductor strip 4, especially in the form of a metal strip, for example in the form of a long metal foil strip, is applied to the edge section or anode layer excess 1a of the anode layer 1, and electrically connected and mechanically connected or contacted therewith. FIG. 2 shows that the anode output conductor strip 4 projects here beyond a lateral edge of the anode layer 1.

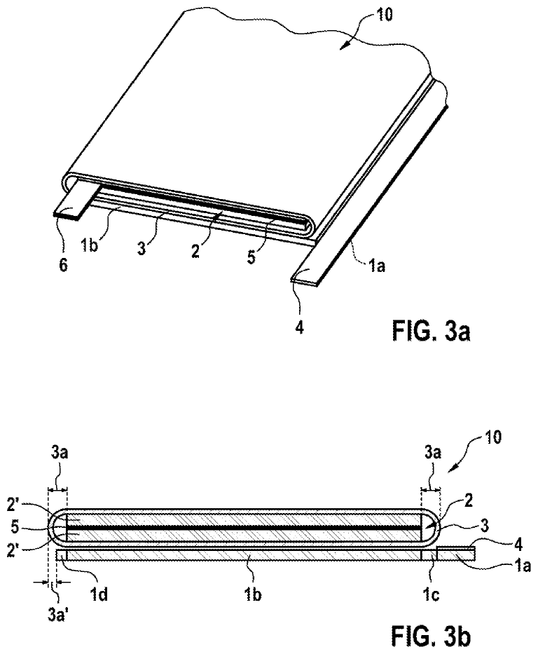

The schematic perspective view in FIG. 3a and the schematic cross section in FIG. 3b illustrate that the anode output conductor strip 4 is especially applied to that side of the edge section or anode layer excess 1a of the anode layer 1 which is arranged on the separator side at a later stage.

FIGS. 3a and 3b show more particularly that—for example in a process step b)—a separator layer 3 and a cathode layer 2 are applied to the anode layer 1 alongside the edge section 1 or anode layer excess 1a and especially alongside the anode output conductor strip 4. It is apparent from FIGS. 3a and 3b that such a cell construction provides sufficient construction space, especially construction height, for the anode output conductor strip 4, such that this 4 can also be configured with a distinctly greater thickness or construction height and to project into the region of the cathode layer thickness.

FIGS. 3a and 3b also illustrate that the anode layer excess 1a projects beyond the separator layer 3 and the cathode layer 2.

It is apparent from FIG. 3b that, in the embodiment shown therein, the anode layer 1 and the separator 3 have a greater area than the cathode layer 2. The separator layer 3 here has separator layer excesses 3a that project beyond the cathode layer 2. In addition, the separator layer 3 has, on the side free of anode layer excess, a separator layer excess 3a′ that projects beyond the anode layer 1. The anode layer 1 here has an anode layer transition section 1c between the anode layer excess 1a and the electrochemically active section 1a of the anode layer 1, which is in an overlapping arrangement with the separator layer excess 3a that projects beyond the cathode layer 1. In addition, the anode layer 1 has an anode layer edge section 1d in an overlapping arrangement with the other separator layer excess 3a that projects beyond the cathode layer 1.

In the context of the embodiment shown in FIGS. 3a to 5, the cathode layer 2 and the separator layer 3 are provided in the form of a cathode layer 2 packed in a packing of separator material 3, especially in the form of a cathode layer 2 inserted into a pouch of separator material 3, and applied to the anode layer 1 alongside the anode output conductor 4. The separator layer 3 here is formed by the packing of separator material.

FIGS. 3a and 3b also show that the cathode layer 2 in the configuration shown therein has a cathode output conductor 5 provided with a cathode layer sheet 2′ on either side and equipped with a cathode output conductor tab 6 for electrical contacting.

FIGS. 1 to 3b show that it is possible in this way to produce a battery cell 10 comprising an anode layer 1, a cathode layer 2 and a separator layer 3 disposed between the anode layer 1 and the cathode layer 2, wherein the anode layer 1 has an anode layer excess 1a that projects beyond the cathode layer 2 and the separator layer 3 and is especially based on the edge section 1a of the anode layer 1, which serves as output conductor and is contacted on the separator side.

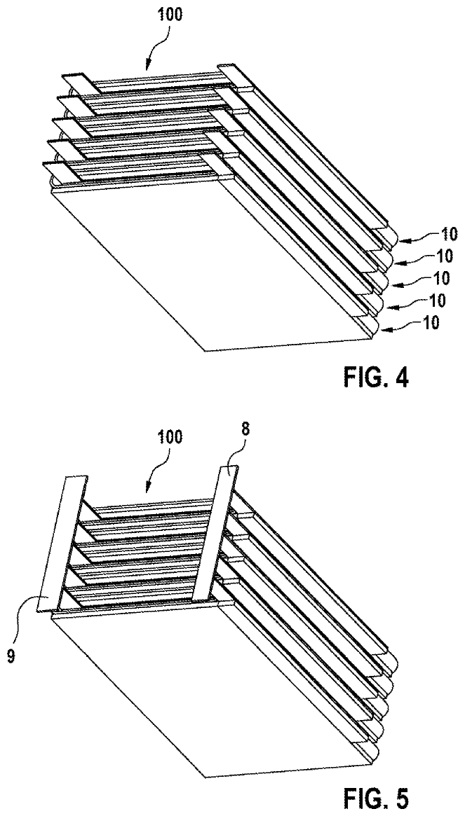

FIG. 4 illustrates that multiple battery cells 10 of this kind—for example in a process step c)—can be stacked in such a way that the anode output conductor strips 4 of the anode layers 1 and the cathode output conductor tabs 6 of the cathode layers 2 are each aligned in a common plane and are especially each also arranged in a straight line. FIG. 4 also shows that the battery cells 10 may also be stacked here in such a way that a cathode layer 2 of each of the battery cells 10 is arranged adjacent to an anode layer 1 of another battery cell 10. FIG. 4 also shows that the packings of separator material 3 in which the cathode layers 2 are packed, in addition to the function as separator, can also implement electrical insulation between the individual battery cells 10.

FIG. 5 shows that—for example in a process step d)—an anode current collector element 8, for example in the form of a further metal strip, is applied to the anode output conductor strips 4, especially to end faces of the anode output conductor strips 4, and electrically connected and mechanically bonded or contacted with these 4, for example by welding, for example by what is called tab welding. In addition, FIG. 5 shows that—for example likewise in process step d)—a cathode current collector element 9, for example in the form of a further metal strip, is also applied to the cathode output conductor tabs 6, especially to end faces of the cathode output conductor tabs 6, and electrically connected and mechanically bonded or contacted with these 6, for example by welding, for example by what is called tab welding.

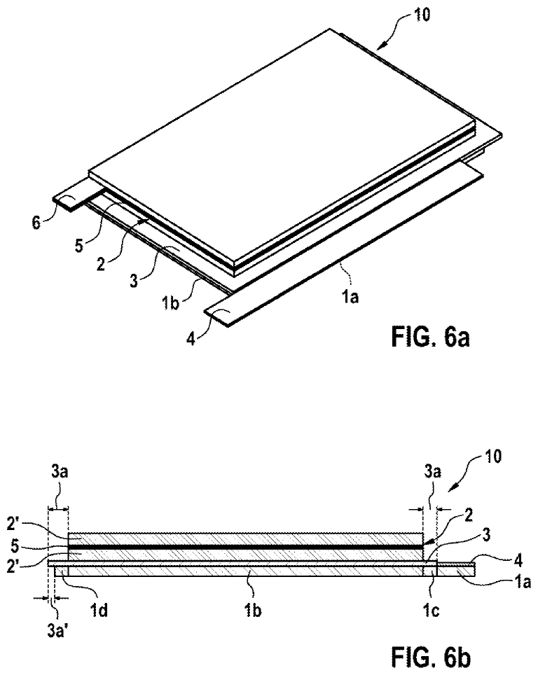

The schematic perspective view in FIG. 6a and the schematic cross section in FIG. 6b illustrate that, in another configuration of the embodiment of a process of the invention shown in FIGS. 1 to 5, the separator layer 3—rather than in the form of a packing of separator material in which the cathode layer 3 is packed as shown in FIGS. 3a to 5—is merely in the form of a simple layer of separator material. FIGS. 6a and 6b show that the separator layer 3 here is applied to the anode layer 1 alongside the edge section 1a of the anode layer 1 and especially also alongside the anode output conductor strip 1b. The cathode layer 2 is applied here in turn to the separator layer 3. In addition, in the configuration shown in FIGS. 6a and 6b, the cathode layer 2 also has a cathode output conductor 5 provided with a cathode layer sheet 2′ on either side and equipped with a cathode output conductor tab 6 for electrical contacting.

It is likewise apparent from FIG. 6b that, in the embodiment shown therein, the anode layer 1 and the separator layer 3 have a greater area than the cathode layer 2. The separator layer 3 has separator layer excesses 3a that project beyond the cathode layer 2. In addition, the separator layer 3 has, on the layer free of anode layer excess, a separator layer excess 3a′ that projects beyond the anode layer 1. The anode layer 1 here has an anode layer transition section 1c between the anode layer excess 1a and the electrochemically active section 1a of the anode layer 1, which is in an overlapping arrangement with the separator layer excess 3a that projects beyond the cathode layer 1. In addition, the anode layer 1 has an anode layer edge section 1d in an overlapping arrangement with the other separator layer excess 3a that projects beyond the cathode layer 1.

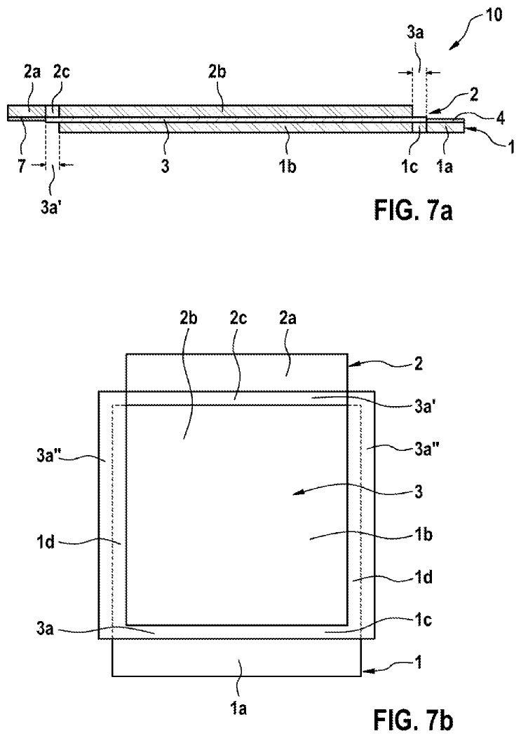

The schematic cross section in FIG. 7a and the schematic top view in FIG. 7b show a further embodiment of a battery cell 10 of the invention, for example a lithium cell or sodium cell 10, comprising an anode layer 1, a cathode layer 2, and a separator layer 3 disposed between the anode layer 1 and the cathode layer 2, and illustrates that the cathode layer 2 may also have a cathode layer excess 2a that projects beyond the anode layer 1 and is especially based on an edge section 2a of the cathode layer 2, which serves as output conductor and is contacted on the separator side.

FIGS. 7a and 7b also show that a cathode output conductor strip 7, especially in the form of a metal strip, for example in the form of a long metal foil strip, has been applied on the cathode layer excess 2a, especially based on an edge section 2a of the cathode layer 2, and has been electrically connected and mechanically bonded or contacted therewith. In this way, it is possible to further reduce the thickness of the battery cell 10 and hence also of a battery based on a cell stack composed of multiple battery cells 10 of this kind.

In the embodiment shown in FIGS. 7a and 7b, the separator layer 3 has separator layer excesses 3a, 3a″ that extend beyond the cathode layer 2 on the sides free of cathode layer excess, and separator layer excesses 3a′, 3a″ that extend beyond the anode layer 1 on the sides free of anode layer excess. The cathode layer 2 here has a cathode layer transition section 2c between the cathode layer excess 2a and the electrochemically active section 2b of the cathode layer 2, which is in an overlapping arrangement with the separator layer excess 3a′ that projects beyond the cathode layer 1.

The anode layer 1 here has an anode layer transition section 1c between the anode layer excess 1a and the electrochemically active section 1b of the anode layer 1, which is in an overlapping arrangement with the separator layer excess 3a that projects beyond the cathode layer 1.

In addition, the anode layer 1 has two anode layer edge sections 1d in an overlapping arrangement with further separator layer excesses 3a″ that project beyond the cathode layer 1.

FIGS. 8a to 8d show schematic cross sections through anode layers 1 or cathode layers 2, and illustrate further configurations of the embodiments of the process of the invention and of the battery cell and battery of the invention that are shown in FIGS. 1 to 7b and 9.

FIG. 8a shows that the edge section 1a, 2a of the anode layer 1 or cathode layer 2 may be coated at least on the separator side with an electrically conductive coating 1a′, 2a′. In this way, it is possible to improve the electrical contacting of the anode output conductor strip or cathode output conductor strip.

FIG. 8b shows that the edge section 1a, 2a of the anode layer 1 or cathode layer 2 may additionally be coated at an end face with an electrically conductive coating 1a″, 2a″. In this way, it is possible to improve the electrical conductivity of the edge section 1a, 2a of the anode layer 1 or cathode layer 2.

FIG. 8c shows that the edge section 1a, 2a of the anode layer 1 or cathode layer 2 can additionally be coated on a surface which is remote from the separator layer 3 of the cell 10 at a later stage with an electrically conductive coating 1a″′, 2a″′. In this way, it is possible to further increase the electrical conductivity of the edge section 1a, 2a of the anode layer 1 or cathode layer 2.

FIG. 8d shows that the electrochemically active section 1b, 2b of the anode layer 1 or cathode layer 2 can additionally be coated on a surface which is remote from the separator layer 3 of the cell 10 at a later stage with an electrically conductive coating 1a″″, 2a″. In this way, it is possible to further increase the electrical conductivity of the anode layer 1 or cathode layer 2.

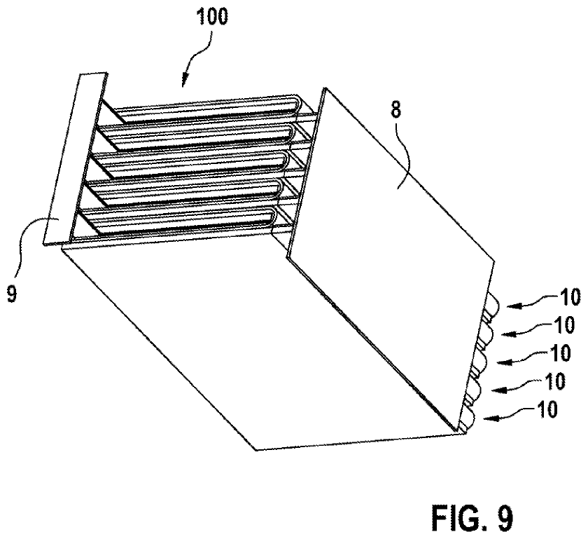

FIG. 9 shows a further embodiment of a battery 100 that differs from the embodiment shown in FIG. 5 essentially in that the anode layer excesses 1a are electrically contacted at the end face. An anode layer contact element and/or anode current collector element 8 has been applied here to the end face of the anode layer excesses 1a.

1. A battery cell (10), comprising
an anode layer (1),
a cathode layer (2) and
a separator layer (3) disposed between the anode layer (1) and the cathode layer (2),
wherein the anode layer (1) has at least one anode layer excess (1a) that projects beyond the separator layer (3), and/or
wherein the cathode layer (2) has at least one cathode layer excess (2a) that projects beyond the separator layer (3),
wherein the at least one anode layer excess (1a) and/or the at least one cathode layer excess (2a) serves as output conductor and is electrically contacted on a separator side and/or at an end face.

2. The battery cell (10) as claimed in claim 1,
wherein the at least one anode layer excess (1a) projects beyond the separator layer (3) and the cathode layer (2), and/or
wherein the at least one cathode layer excess (2a) projects beyond the separator layer (3) and the anode layer (1).

3. The battery cell (10) as claimed in claim 1, wherein the at least one anode layer excess (1a) and/or the at least one cathode layer excess (2a) is electrically contacted on the separator side or on the separator side and at the end face.

4. The battery cell (10) as claimed in claim 1, wherein the anode layer (1) and/or the cathode layer (2) is a self-supporting layer.

5. The battery cell (10) as claimed in claim 1,
wherein the anode layer (1) has a layer thickness within a range from ≥20 μm to ≤400 μm and/or
wherein the cathode layer (2) has a layer thickness within a range from ≥20 μm to ≤600 μm.

6. The battery cell (10) as claimed in claim 1, wherein the at least one anode layer excess (1a) extends over a length of the anode layer (1), and/or wherein the at least one cathode layer excess (2a) extends over a length of the cathode layer (2).

7. The battery cell (10) as claimed in claim 1,
wherein an anode layer contact element (4) for electrical contacting of the anode layer (1) has been applied on the separator side and/or at the end face on the at least one anode layer excess (1a) and/or
wherein a cathode layer contact element (7) for electrical contacting of the cathode layer (2) has been applied on the separator side and/or at the end face on the at least one cathode layer excess (2a).

8. The battery cell (10) as claimed in claim 1,
wherein the anode layer contact element (4) projects at least beyond an edge of the anode layer (1) and/or
wherein the cathode layer contact element (7) projects at least beyond an edge of the cathode layer (2).

9. The battery cell (10) as claimed in claim 1,
wherein the at least one anode layer excess (1a) and/or the at least one cathode layer excess (2a) has been provided with an electrically conductive coating (1a′, 2a′) on the separator side, and/or
wherein the at least one anode layer excess (1a) and/or the at least one cathode layer excess (2a) has been provided with an electrically conductive coating (1a″, 2a″) at an end face, and/or
wherein the at least one anode layer excess (1a) and/or the at least one cathode layer excess (2a) has been provided with an electrically conductive coating (1a″′, 2a″′) remote from the separator, and/or
wherein an electrochemically active section (1b) of the anode layer (1) and/or an electrochemically active section (2b) of the cathode layer (2) has been provided with an electrically conductive coating (1a″″, 2a″″) remote from the separator.

10. The battery cell (10) as claimed in claim 1, wherein
the electrically conductive coating (1a′, 2a′) on the separator side of the at least one anode layer excess (1a) and/or of the at least one cathode layer excess (2a), and/or
the electrically conductive coating (1a″, 2a″) at the end face of the at least one anode layer excess (1a) and/or of the at least one cathode layer excess (2a), and/or
the electrically conductive coating (1a″′, 2a″′; 1a″″, 2a″″) remote from the separator on the at least one anode layer excess (1a) and/or on the at least one cathode layer excess (2a) and/or on the electrochemically active section (1b) of the anode layer (1) and/or on the electrochemically active section (2b) of the cathode layer (2)
is a metallic coating.

11. The battery cell (10) as claimed in claim 1, wherein
the electrically conductive coating (1a′, 2a′) on the separator side of the at least one anode layer excess (1a) and/or of the at least one cathode layer excess (2a), and/or
the electrically conductive coating (1a″, 2a″) at the end face of the at least one anode layer excess (1a) and/or of the at least one cathode layer excess (2a), and/or
the electrically conductive coating (1a″′, 2a″′; 1a″″, 2a″″) remote from the separator on the at least one anode layer excess (1a) and/or on the at least one cathode layer excess (2a) and/or on the electrochemically active section (1b) of the anode layer (1) and/or on the electrochemically active section (2b) of the cathode layer (2)
has a layer thickness of ≤5 μm.

12. The battery cell (10) as claimed in claim 1, wherein the separator layer (3) has, on at least one side free of anode layer excess, at least one separator layer excess (3a′, 3a″) that projects beyond the anode layer (1) and/or, on at least one side free of cathode layer excess, at least one separator layer excess (3a, 3a″) that projects beyond the cathode layer (2).

13. The battery cell (10) as claimed in claim 1, wherein the separator layer (3) is formed by a packing of separator material in which the cathode layer (2) is packed.

14. A battery (100), comprising at least one battery cell (10) as claimed in claim 1.

15. The battery (100) as claimed in claim 14, wherein the battery cells (10) are stacked in such a way that the anode layer contact elements (4) and/or the cathode layer contact elements (6, 7) are each aligned in a common plane.

16. The battery (100) as claimed in claim 14,
wherein an anode current collector element (8) has been secured on the anode layer contact elements (4), and/or
wherein a cathode current collector element (9) has been secured on the cathode layer contact elements (6, 7).

17. A process for producing a battery cell (10) as claimed in claim 1, in which
an anode layer contact element (4) for electrical contacting of the anode layer (1) has been applied to at least one edge section (1a) and/or to at least one end face of an anode layer (1), and is electrically connected and mechanically bonded to the at least one edge section (1a) and/or to the at least one end face, and
a separator layer (3) is applied to the anode layer (1) and a cathode layer (2) is applied thereto (3) alongside the anode layer contact element (4) and/or
in which
a cathode layer contact element (7) for electrical contacting of the cathode layer (2) has been applied to at least one edge section (2a) and/or to at least one end face of a cathode layer (2), and is electrically connected and mechanically bonded to the at least one edge section (2a) and/or to the at least one end face, and
a separator layer (3) is applied to the cathode layer (2) and an anode layer (1) is applied thereto (3) alongside the cathode layer contact element (7).

18. The process as claimed in claim 17, wherein the anode layer contact element (4), and/or the cathode layer contact element (7), is applied to the edge section in such a way that the anode layer contact element (4) or the cathode layer contact element (7) projects beyond an edge of the anode layer (1) or beyond an edge of the cathode layer (2).

19. The process as claimed in claim 17,
wherein a cathode layer (2) packed in a packing of separator material has been applied to the anode layer (1) alongside the anode layer contact element (4), and/or
wherein an anode layer (1) packed in a packing of separator material has been applied to the cathode layer (2) alongside the cathode layer contact element (7).

20. The process as claimed in claim 17, wherein two or more battery cells (10) each having an anode layer (1), a cathode layer (2) and a separator layer (3) disposed in between, and at least one anode layer contact element (4) and/or at least one cathode layer contact element (7) are stacked in such a way that the anode layer contact elements and/or the cathode layer contact elements (7) are each aligned in a common plane.

21. A battery (100), comprising a cell stack composed of two or more battery cells (10) as claimed in claim 1.
